(19) United States
(12) Patent Application Publication
(10) Pub. No.: US 2023/0174002 A1
(43) Pub. Date: Jun. 8, 2023

(54) WIRE HARNESS FIXING MEMBER AND WIRE HARNESS

(71) Applicant: SUMITOMO WIRING SYSTEMS, LTD., Mie (JP)

(72) Inventor: Hisashi SAKURAI, Mie (JP)

(21) Appl. No.: 17/922,285

(22) PCT Filed: May 14, 2021
(86) PCT No.: PCT/JP2021/018385

§ 371 Date: Oct. 28, 2022

(30) Foreign Application Priority Data
May 15, 2020 (JP) 2020-086018

(51) Int. Cl. B60R 16/02; H02G 3/30; F16B 5/02

(52) U.S. Cl. CPC B60R 16/0215; H02G 3/30; F16B 5/02

(57) ABSTRACT

A fixing member includes a fixing member body, and a tubular collar that is separate from the fixing member body. The fixing member body includes a fixed portion configured to be fixed to a bolt extending from an attachment surface on a vehicle body side, and a holding part that holds the wire harness body. The fixed portion includes a front surface that opposes the attachment surface Pa, and a through hole that extends therethrough from the front surface to a back surface side and in which the collar is provided. An inner circumferential surface of the through hole includes a collar placement portion in which the collar is disposed, and an inclined portion located between the collar placement portion and the front surface. Also, the inclined portion is inclined to a central axis side of the through hole toward the collar placement portion side.

### TECHNICAL FIELD

The present disclosure relates to a wire harness fixing member and a wire harness.

### BACKGROUND

Patent Document 1 describes a wire harness fixing member for fixing a wire harness to a vehicle body as a mounting target. The wire harness fixing member includes a fixing member body, and a tubular collar that is separate from the fixing member body. The fixing member body is formed of a synthetic resin, for example. The collar is formed of a material having a higher rigidity than the fixing member body, such as a metal material. A bolt extending from the vehicle body side is passed through the collar, and a nut is fastened the bolt, whereby the wire harness fixing member is fixed to the vehicle body, and thus the wire harness is held thereby.

### PRIOR ART DOCUMENT

### Patent Document

Patent Document 1: JP 2008-286218 A

### SUMMARY OF THE INVENTION

### Problems to be Solved

When inserting the bolt on the vehicle body side into the collar in the wire harness fixing member as described above, the direction in which a portion of the fixing member that includes the collar is attached to the bolt does not necessarily extend in the axial direction of the bolt.

For example, the wire harness may be fixed to the vehicle body at a fixing point other than the fixing member before fixing the wire harness to the vehicle body using the fixing member. In this case, the wire harness is held at a position close to the vehicle body via the fixing point other than the fixing member. Accordingly, constraints may be imposed on the direction in which the fixing member is attached to the bolt. On the other hand, in the case of attaching the fixing member to the wire harness before attaching the fixing member to the vehicle body, the fixing member may be attached to the bolt by pivoting the fixing member about the wire harness serving as an axis. In this case, it is difficult to insert the bolt into the collar, thus causing a reduction in the ease of attachment of the fixing member.

Therefore, an object of the present disclosure is to provide a wire harness fixing member and a wire harness that can increase the ease of attachment to a mounting target.

### Means to Solve the Problem

A wire harness fixing member according to the present disclosure is a wire harness fixing member for fixing a wire harness body to a mounting target, including: a fixing member body; and a tubular collar that is separate from the fixing member body, wherein the fixing member body includes a fixed portion configured to be fixed to a bolt extending from an attachment surface of the mounting target, and a holding part that holds the wire harness body, the fixed portion includes a front surface that opposes the attachment surface, and a through hole that extends therethrough from the front surface to a back surface side and in which the collar is provided, the bolt is passed through the collar, an inner circumferential surface of the through hole includes a collar placement portion in which the collar is disposed, and an inclined portion located between the collar placement portion and the front surface, and the inclined portion is inclined from the front surface to a central axis side of the through hole toward the collar placement portion side.

A wire harness according to the present disclosure includes a wire harness body, and the above-described wire harness fixing member.

### Effect of the Invention

According to the present disclosure, it is possible to provide a wire harness fixing member and a wire harness that can increase the ease of attachment to a mounting target.

### BRIEF DESCRIPTION OF THE DRAWINGS

FIG. 1 is a cross-sectional view showing a schematic configuration of a wire harness according to an embodiment.

FIG. 2 is a plan view showing a schematic configuration of the wire harness according to the embodiment.

FIG. 3 is an enlarged cross-sectional view showing relevant parts of the wire harness according to the embodiment.

FIG. 4 is a cross-sectional view illustrating a mode of attachment of the wire harness according to the embodiment.

FIG. 5 is an enlarged cross-sectional view showing relevant parts of a wire harness according to a modification.

FIG. 6 is an enlarged cross-sectional view showing relevant parts of a wire harness according to a modification.

### DETAILED DESCRIPTION TO EXECUTE THE INVENTION

### Description of Embodiments of the Present Disclosure

First, aspects of the present disclosure will be listed and described.

[1] A wire harness fixing member according to the present disclosure is a wire harness fixing member for fixing a wire harness body to a mounting target, including: a fixing member body; and a tubular collar that is separate from the fixing member body, wherein the fixing member body includes a fixed portion configured to be fixed to a bolt extending from an attachment surface of the mounting target, and a holding part that holds the wire harness body, the fixed portion includes a front surface that opposes the attachment surface, and a through hole that extends therethrough from the front surface to a back surface side and in which the collar is provided, the bolt is passed through the collar, an inner circumferential surface of the through hole includes a collar placement portion in which the collar is disposed, and an inclined portion located between the collar placement portion and the front surface, and the inclined portion is inclined from the front surface to a central axis side of the through hole toward the collar placement portion side.

With this configuration, when inserting the bolt on the mounting target into the collar disposed in the through hole of the fixing member body, it is possible to guide a distal end of the bolt toward the collar by the inclination of the inclined portion of the through hole. This makes it possible to easily insert the bolt on the vehicle body side into the collar even if constraints are imposed on the direction in which the fixing member is attached to the bolt on the mounting target. Accordingly, it is possible to increase the ease of attachment of the fixing member to the mounting target.

[2] The collar has an inner diameter that is uniform in an axial direction thereof. With this configuration, it is possible to increase the ease of attachment of the fixing member to the mounting target while using the collar having a simple shape by changing the shape of the through hole of the fixing member body, or in other words, by additionally providing the inclined portion.

[3] The collar includes a flange portion extending radially outward from one end portion of the collar in the axial direction, and the through hole includes, at an end portion of the collar placement portion on the inclined portion side, a step portion that abuts against the flange portion in the axial direction of the collar. With this configuration, it is possible to support the flange portion of the collar in the axial direction of the collar by the step portion in a configuration in which the through hole of the fixing member body is provided with the inclined portion.

[4] A radial position of an end portion of the inclined portion on the collar placement portion side coincides with a position of an inner circumferential surface of the collar, as viewed in the axial direction of the collar. With this configuration, when inserting the bolt on the mounting target into the collar disposed in the through hole of the fixing member body, it is possible to guide a distal end of the bolt to the inner circumferential surface of the collar by the inclined portion of the through hole. This makes it possible to even more easily insert the bolt into the collar.

[5] A wire harness according to the present disclosure includes a wire harness body, and the above-described wire harness fixing member.

With this configuration, it is possible to increase the ease of attachment of the fixing member to the mounting target by the inclined portion of the through hole of the wire harness fixing member.

### Details of Embodiments of the Present Disclosure

Specific examples of the wire harness fixing member and the wire harness according to the present disclosure will be described below with reference to the drawings. In the drawings, portions of configurations are shown exaggerated or simplified in some cases for convenience of description. Also, dimensional proportions of the portions may be different from the actual dimensional proportions in the drawings. Being “perpendicular” as used herein includes not only being exactly perpendicular, but also being substantially perpendicular, as long as the operations and effects of the present embodiment can be achieved. It should be noted that the present invention is not limited to these examples, but is defined by the claims, and is intended to include all modifications which fall within the scope of the claims and the meaning and scope of equivalents thereof.

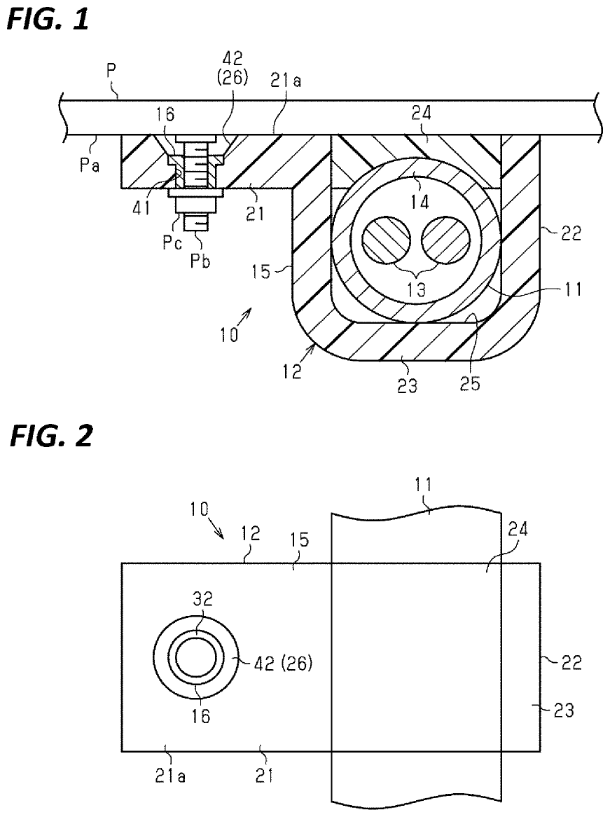

As shown in FIG. 1, a vehicle wire harness 10 includes a wire harness body 11, and a fixing member 12 for fixing the wire harness body 11 to an attachment surface Pa of a vehicle body panel P.

The wire harness body 11 includes at least one wire 13, and a tubular exterior member 14 that surrounds the outer circumference of the wire 13. The exterior member 14, as a whole, has an elongated tubular shape. The transverse cross-sectional shape of the exterior member 14 of the present embodiment is a circular shape. The exterior member 14 of the present embodiment is formed by a metal pipe, for example. The number of wires 13 that are passed through the exterior member 14 is one, or more than one.

The term “tubular” as used herein may be any shape that can be regarded as being tubular as a whole, and includes a tubular shape formed by a combination of a plurality of components, and a tubular shape having a partially cut-out portion or the like, such as a C-shape. The exterior member 14 of the present embodiment is formed by one component.

Fixing Member 12

As shown in FIGS. 1 and 2, the fixing member 12 includes a fixing member body 15, and a tubular collar 16 provided in the fixing member body 15.

The fixing member body 15 is an injection-molded article made of a synthetic resin material, for example. The fixing member body 15 includes a fixed portion 21 configured to be fixed to the attachment surface Pa of the vehicle body panel P, and a holding part 22 that holds the wire harness body 11.

A fixing bolt Pb extends from the attachment surface Pa of the vehicle body panel P. The bolt Pb is formed by a circular cylinder having a thread on an outer circumferential surface thereof. The bolt Pb is substantially perpendicular to the attachment surface Pa, for example.

The holding part 22 of the fixing member body 15 has, for example, a tubular shape that surrounds the outer circumference of the wire harness body 11. For example, the holding part 22 includes a body-side portion 23 and a cover portion 24. The body-side portion 23 is formed in a single piece with the fixed portion 21. For example, the body-side portion 23 includes a recess 25 that is open toward the attachment surface Pa. The cover portion 24 is attached to the body-side portion 23 so as to close the opening of the recess 25 on the attachment surface Pa side. The holding part 22 is formed in a tubular shape by the body-side portion 23 and the cover portion 24, and the wire harness body 11 is passed through the inside of the tubular shape of the holding part 22.

The fixed portion 21 of the fixing member body 15 is a portion extending from the body-side portion 23 of the holding part 22. The fixed portion 21 is fixed to the bolt Pb. The fixed portion 21 has a plate shape, for example. In a state in which the fixed portion 21 is attached to the attachment surface Pa, a surface of the fixed portion 21 that opposes the attachment surface Pa is a front surface 21a, and a side opposite thereto is a back surface 21b.

Note that the term “oppose” as used herein refers to that surfaces or members are located in front of each other, and includes not only a case where they are located fully in front of each other, but also a case where they are located partially in front of each other. Also, the term “oppose” as used herein includes both a case where two portions oppose with a portion other than the two portions interposed therebetween, and a case where two portions oppose with nothing interposed therebetween. Also, the term “oppose” as used herein includes both a case where two opposing portions are in contact, and a case where two portions are spaced apart. In the present embodiment, for example, the attachment surface Pa and the front surface 21a of the fixed portion 21 are in contact with each other.

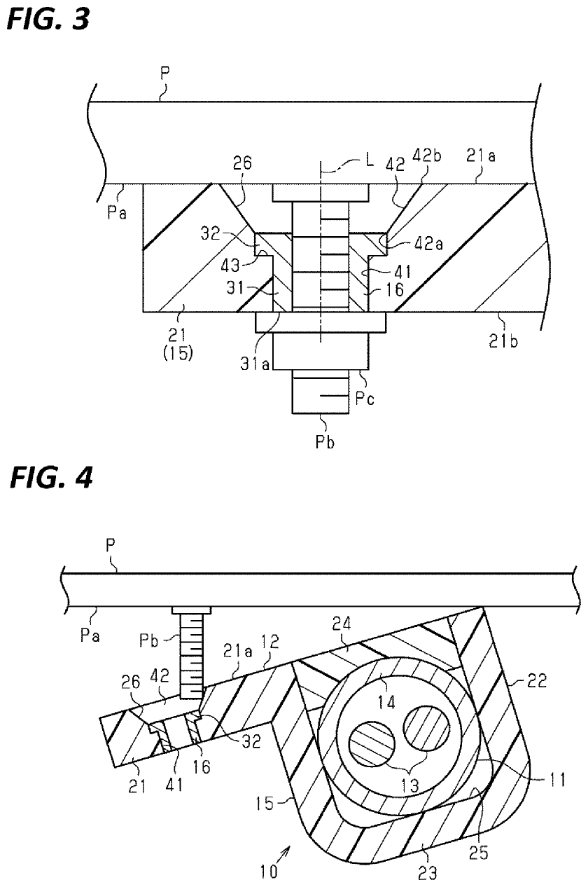

As shown in FIG. 3, the fixed portion 21 has a through hole 26 extending therethrough from the front surface 21a of the fixed portion 21 to the back surface 21b. The through hole 26 extends through the fixed portion 21, for example, in the thickness direction of the fixed portion 21. The tubular collar 16 is provided in the through hole 26. The collar 16 is disposed in the through hole 26 such that the axial direction of the collar 16 extends in the thickness direction of the fixed portion 21. The bolt Pb is passed through the collar 16.

The collar 16 is formed of a material having a higher rigidity than the fixing member body 15, such as a metal material. The collar 16 includes a collar body portion 31 and a flange portion 32. The collar body portion 31 has a cylindrical shape, for example. The inner circumferential surface of the collar body portion 31 has a circular shape as viewed in the axial direction. The inner diameter and the outer diameter of the collar body portion 31 are uniform in the axial direction. The flange portion 32 extends radially outward from one end portion of the collar body portion 31 in the axial direction. The outer shape of the flange portion 32, as viewed in the axial direction, is a circular shape, for example.

The inner circumferential surface of the through hole 26 includes a collar placement portion 41 in which the collar 16 is disposed, and an inclined portion 42 located between the collar placement portion 41 and the front surface 21a. The collar placement portion 41 and the inclined portion 42 are arranged side by side in the axial direction of the through hole 26, or in other words, the thickness direction of the fixing member 12. Note that the axial direction of the through hole 26 is the through direction of the through hole 26. In the following, the axial direction of the through hole 26 may simply be referred to as the “axial direction”.

The inclined portion 42 is provided on the front surface 21a side of the collar placement portion 41 and the collar 16. The inclined portion 42 is inclined to the central axis L side of the through hole 26 toward the collar placement portion 41 side.

For example, the inclined portion 42 has the shape of a circle around the central axis of the through hole 26, as viewed in the axial direction of the through hole 26. That is, the inclined portion 42 is provided on the entire circumference of an end portion of the through hole 26 on the front surface 21a side. In addition, the inclined portion 42 is tapered such that the diameter thereof is reduced toward the collar placement portion 41 side, for example.

An end portion 42a of the inclined portion 42 on the collar 16 side, or in other words, an end portion 42a of the inclined portion 42 on the reduced diameter side is continuous with the collar placement portion 41. The diameter of the end portion 42a of the inclined portion 42 is set to be equal to the outer diameter of the flange portion 32 of the collar 16, for example. An end portion of the inclined portion 42 that is opposite to the end portion 42a in the axial direction, or in other words, an end portion 42b of the inclined portion 42 on the increased diameter side is continuous with the front surface 21a of the fixed portion 21. That is, the inclined portion 42 is formed in a range extending from the end portion of the collar placement portion 41 on the inclined portion 42 side to the front surface 21a of the fixed portion 21 in the axial direction of the through hole 26.

The collar placement portion 41 of the present embodiment includes a step portion 43 having a shape resembling the shape of the flange portion 32 of the collar 16. The step portion 43 supports the flange portion 32. The step portion 43 is in contact with one side surface of the flange portion 32 in the axial direction, and the outer circumferential surface of the flange portion 32. As a result of the step portion 43 abutting against the flange portion 32 in the axial direction of the collar 16, the collar 16 is prevented from being dislodged from the through hole 26.

For the fixing member 12 of the present embodiment, after the fixing member body 15 has been molded, the collar 16 is disposed in the collar placement portion 41 of the through hole 26. Then, the collar 16 is fixed to the fixing member body 15 through crimping, for example. In fixing through crimping, for example, one or a plurality of locations in the circumferential direction of an end portion 31a of the collar body portion 31 that is on a side opposite to the flange portion 32 are plastically deformed radially outward, whereby the plastically deformed portion or portions of the end portion 31a bite into the inner circumferential surface of the through hole 26. Thus, the collar 16 is fixed to the through hole 26 in the circumferential direction and the axial direction.

Next, a mode of attachment of the wire harness 10 of the present embodiment to the attachment surface Pa of the vehicle body panel P will be described together with the effects thereof.

First, the fixing member 12 is attached to the wire harness body 11. At this time, the wire harness body 11 is fitted into the recess 25 of the holding part 22, and the opening of the recess 25 is closed by the cover portion 24 in this state. Thus, the wire harness body 11 is held by the holding part 22.

Thereafter, the wire harness body 11 is fixed to the vehicle body panel P at a fixing point other than the fixing member 12. Thus, the wire harness body 11 is brought into proximity to the vehicle body panel P although the fixing member 12 is not fixed to the vehicle body panel P.

Next, with the wire harness body 11 in proximity to the vehicle body panel P, the fixing member 12 is fixed to the vehicle body panel P.

As shown in FIG. 4, first, the fixing member 12 is pivoted about the wire harness body 11 serving as an axis, thus inserting the bolt Pb on the vehicle body panel P side into the collar 16 of the fixing member 12. At this time, when a distal end of the bolt Pb comes into contact with the inclined portion 42 of the through hole 26, the distal end of the bolt Pb is guided to the collar 16 by the inclination of the inclined portion 42. This facilitates insertion of the bolt Pb into the collar 16.

Since the inclined portion 42 is provided at the end portion of the through hole 26 on the front surface 21a side, the through hole 26 has a shape in which the diameter of an end portion on the inlet side when inserting the bolt Pb is increased. This facilitates insertion of the distal end of the bolt Pb into the through hole 26. Since the inclined portion 42 is provided on the entire circumference of the end portion of the through hole 26 on the front surface 21a side, the inclined portion 42 accommodates displacement of the fixing member 12 in the length direction of the wire harness body 11, and displacement of the fixing member 12 in the direction in which the fixed portion 21 and the holding part 22 are arranged side by side.

After the bolt Pb has been inserted into the collar 16, a nut Pc is screwed to a portion of the bolt Pb that protrudes from the collar 16, whereby the collar 16 and the fixed portion 21 are fastened and fixed to the vehicle body panel P, as shown in FIG. 1.

The effects of the present embodiment will be described.

(1) An inner circumferential surface of the through hole 26 of the fixing member body 15 includes a collar placement portion 41 in which the collar 16 is disposed, and an inclined portion 42 located between the collar placement portion 41 and the front surface 21a. Also, the inclined portion 42 is inclined from the front surface 21a to the central axis L side of the through hole 26 toward the collar placement portion 41 side. With this configuration, when inserting the bolt Pb on the vehicle body side into the collar 16 disposed in the through hole 26 of the fixing member body 15, it is possible to guide a distal end of the bolt Pb toward the collar 16 by the inclination of the inclined portion 42 of the through hole 26. This makes it possible to easily insert the bolt Pb on the vehicle body side into the collar 16 even if constraints are imposed on the direction in which the fixing member 12 is attached to the bolt Pb. Accordingly, it is possible to increase the ease of attachment of the fixing member 12 to the vehicle body panel P.

(2) The collar 16 has an inner diameter that is uniform in an axial direction thereof. With this configuration, it is possible to increase the ease of attachment of the fixing member 12 to the vehicle body panel P while using the collar 16 having a simple shape, by changing the shape of the through hole 26 of the fixing member body 15, or in other words, by additionally providing the inclined portion 42.

(3) The collar 16 includes a flange portion 32 extending radially outward from one end portion of the collar 16 in the axial direction. Also, the through hole 26 includes, at an end portion of the collar placement portion 41 on the inclined portion 42 side, a step portion 43 that abuts against the flange portion 32 in the axial direction of the collar 16. With this configuration, it is possible to support the flange portion 32 in the axial direction of the collar 16 by the step portion 43 in a configuration in which the through hole 26 is provided with the inclined portion 42.

The present embodiment can be implemented with the following modifications. The present embodiment and the following modifications can be implemented in combination with each other as long as there are no technical discrepancies.

The through hole 26 in the above embodiment includes, at an end portion of the collar placement portion 41 on the inclined portion 42 side, a step portion 43 that abuts against the flange portion 32 in the axial direction of the collar 16. That is, in the above embodiment, the flange portion 32 is provided at the end portion of the collar 16 on the front surface 21a side. However, the present disclosure is not particularly limited thereto.

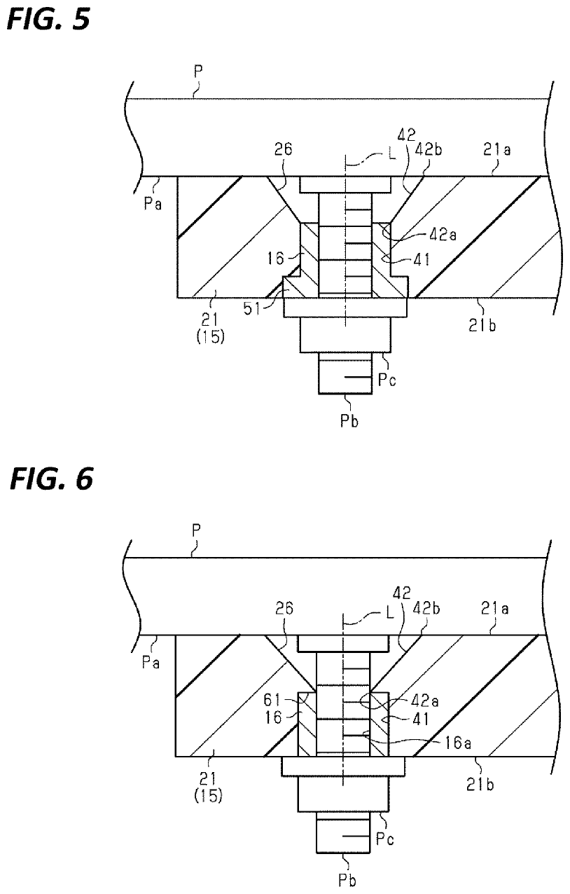

For example, as shown in FIG. 5, the flange portion 32 and the step portion 43 in the above embodiment may be omitted, and a flange portion 51 may be provided at an end portion of the collar 16 on the back surface 21b side. The flange portion 51 extends radially outward from the end portion of the collar 16 on the back surface 21b side. With this configuration, the nut Pc that is screwed to the bolt Pb can abut against the flange portion 51 of the collar 16. Accordingly, it is possible to increase the contact area between the collar 16 and the nut Pc. As a result, the fixing member 12 can be suitably fastened and fixed to the vehicle body panel P using the bolt Pb and the nut Pc. Note that in the example shown in FIG. 5, the collar 16 is fixed at the end portion of the collar 16 on the front surface 21a side through crimping, for example.

For example, as shown in FIG. 6, the flange portion 32 may be omitted from the collar 16 in the above embodiment, and the collar 16 may have an outer diameter that is uniform in the axial direction. With this configuration, the shape of the collar 16 can be further simplified.

In the example shown in FIG. 6, the radial position of the end portion 42a of the inclined portion 42 on the collar placement portion 41 side coincides with the position of an inner circumferential surface 16a of the collar 16, as viewed in the axial direction of the collar 16. That is, the end portion 42a of the inclined portion 42 on the reduced diameter side is directly continuous with the inner circumferential surface 16a of the collar 16. With this configuration, when inserting the bolt Pb on the vehicle body side into the collar 16 disposed in the through hole 26 of the fixing member body 15, it is possible to guide a distal end of the bolt Pb to the inner circumferential surface 16a of the collar 16 by the inclination of the inclined portion 42 of the through hole 26. This makes it possible to even more easily insert the bolt Pb in the collar 16.

Note that in the example shown in FIG. 6, the through hole 26 includes an abutment portion 61 that abuts against the end portion of the collar 16 on the front surface 21a side in the axial direction. For example, the collar 16 is fixed at the end portion of the collar 16 on the back surface 21b through crimping.

Although the inclined portion 42 of the above embodiment is provided on the entire circumference of the through hole 26, the present disclosure is not limited thereto. The inclined portion 42 may be provided on a portion of the circumference of the through hole 26.

The transverse cross-sectional shape of the collar 16 is not limited to a circular shape, and may be an elliptic shape or a polygonal shape, for example. When the transverse cross-sectional shape of the collar 16 is a shape having a longitudinal direction, such as an elliptic shape, as viewed in the axial direction of the collar 16, the longitudinal direction preferably extends in a direction extending in the length direction of the wire harness body 11, or a direction extending in the direction in which the fixed portion 21 and the holding part 22 are arranged side by side.

The fixing member 12 may be formed by insert molding the fixing member body 15 using the collar 16 as an insert.

The transverse cross-sectional shape of the exterior member 14 is not limited to a circular shape, and may be any shape, including, for example, an elliptic shape and a polygonal shape.

The exterior member 14 may be a flexible corrugated tube made of a synthetic resin or the like.

In the above embodiment, the present disclosure is applied to the fixing member 12 for fixing the wire harness body 11 to the vehicle body panel P. However, the present disclosure is not particularly limited thereto, and is also applicable to a fixing member for fixing the wire harness body 11 to a mounting target other than the vehicle body panel P.

As shown in FIGS. 2 and 3, an opening edge of the through hole 26 on the front surface 21a side, or in other words, the end portion 42b of the inclined portion 42 on the increased diameter side may be referred to as an upper opening edge of the through hole 26 or an inlet of the bolt Pb. An opening edge of the through hole 26 on the back surface 21b side may be referred to as a lower opening edge or an outlet of the bolt Pb. The end portion 42a of the inclined portion 42 on the reduced diameter side may be referred to as an intermediate opening edge of the through hole 26. The inner diameters of the upper opening edge, the lower opening edge, and the intermediate opening edge may be reduced in the order of the upper opening edge, the intermediate opening edge, and the lower opening edge. That is, the through hole 26 may include an upper opening edge having a large diameter or a first diameter, a lower opening edge having a small diameter or a second diameter smaller than the first diameter, and an intermediate opening edge having an intermediate diameter or a third diameter between the first diameter and the second diameter.

As shown in FIG. 3, in a state in which the fixing member 12 is completely fixed to the vehicle body panel P, a shaft portion of the bolt Pb may include a first length portion that protrudes from the through hole 26 and that includes a distal end of the shaft portion, a second length portion that is continuous with the first length portion and that is covered by the collar 16, and a third length portion that is continuous with the second length portion and that includes a proximal end of the shaft portion. The third length portion may be surrounded by the inclined portion 42 in a non-contact manner. In other words, the entire inclined portion 42 of the through hole 26 that includes the upper opening edge (42b) and the intermediate opening edge (42a) may be spaced apart from the shaft portion of the bolt Pb. Thus, in a state in which the fixing member 12 is completely fixed to the vehicle body panel P, an annular space may be formed between the inclined portion 42 of the through hole 26 and the shaft portion of the bolt Pb.

As shown in FIG. 3, the inclined portion 42 may be inclined so as to approach the central axis L of the through hole 26 in a direction from the front surface 21a toward the collar placement portion 41. The collar placement portion 41 may be referred to as a collar placement region or a straight bore, and the inclined portion 42 may be referred to as an inclined region or a conical hole. The depth of the conical hole may be comparable to the thickness of the shaft portion of the bolt Pb or the inner diameter of the collar 16, or may be larger than the thickness of the shaft portion. As in the illustrated non-limiting example, the depth of the conical hole may be about 50% of the thickness of the fixed portion 21. The maximum inner diameter of the conical hole, or in other words, the inner diameter of the inlet of the bolt Pb may be larger than the thickness of the shaft portion, or may exceed twice the thickness of the shaft portion as in the illustrated non-limiting example.

As shown in FIG. 3, the step portion 43 may abut against the flange portion 32 in the axial direction of the collar 16 from the back surface 21b side. As shown in FIG. 5, the through hole 26 may include a step portion that abuts against the flange portion 51 in the axial direction of the collar 16 from the front surface 21a side. As shown in FIG. 6, the abutment portion 61 may abut against the end portion of the collar 16 on the front surface 21a side in the axial direction of the collar 16 from the front surface 21a side. The step portion 43 of FIG. 3, the step portion of FIG. 5, and the abutment portion 61 of FIG. 6 may each be referred to as a collar stopper.

As shown in FIG. 3 or 5, the radial position of the end portion 42a of the inclined portion 42 on the collar placement portion 41 side may be at the radially innermost edge of the inclined portion 42. The radially outermost edge of the upper end of the collar 16 may coincide with the radially innermost edge of the inclined portion 42. That is, the end portion 42a of the inclined portion 42 on the reduced diameter side may be directly continuous with the outer circumferential surface of the collar 16, for example, without any radial gap and/or axial gap interposed therebetween. An end face of the collar 16 that faces the inside of the inclined portion 42 of the through hole 26 may define a plane orthogonal to the central axis L of the through hole 26. Accordingly, when mounting the fixing member 12 to the bolt Pb (see FIG. 4), the distal end of the bolt Pb abuts against the end face, whereby relative movement between the bolt Pb and the fixing member 12 is instantaneously interrupted, or the speed of the relative movement is temporarily reduced, thus making it possible to prevent the bolt Pb from being ejected with force from the collar 16, for example.

As shown in FIG. 3, the inner diameter of the collar 16 may be uniform over the entire length of the collar 16 or the central hole of the collar 16. As shown in FIG. 6, the inner diameter and the outer diameter of the collar 16 may be uniform over the entire length of the collar 16 or the central hole of the collar 16.

As shown in FIGS. 1 and 2, the body-side portion 23 of the holding part 22 may have, on a side that is continuous with the front surface 21a, a lateral opening (harness receptacle). The cover portion 24 may close the lateral opening. The outer surface of the cover portion 24 may be flush with the front surface 21a. The inner surface of the cover portion 24 may include an arc surface resembling the outer circumferential surface of the exterior member 14. The cover portion 24 may be referred to as a harness stabilizer. The fixing member 12 may be referred to as a bracket, and the fixing member body 15 may be referred to as a bracket body. The body-side portion 23 may be referred to as a tube defining portion.

The present disclosure encompasses the following implementation examples. Reference numerals are assigned to some of the constituent elements of the exemplary embodiments, not for limiting purpose, but for better understanding. Some of the matters described in the following implementation examples may be omitted, and some of the matters described in the implementation examples may be selected or extracted for combination.

Appendix 1

A bracket (12) according to some aspects of the present disclosure may include:

a bracket body (15); and

a tubular collar (16) that is separate from the bracket body (15),

wherein the bracket body (15) may include a plate-shaped fixed portion (21), and a tubular holding part (22),

the fixed portion (21) may include a front surface (21a), a back surface (21b) that is opposite to the front surface (21a), and a through hole (26) that extends therethrough from the front surface (21a) to the back surface (21b) side and in which the collar (16) is provided,

an inner circumferential surface of the through hole (26) may include a collar placement region (41) in which the collar (16) is disposed, and an inclined region (42) located between the collar placement region (41) and the front surface (21a), and

the inclined region (42) may be inclined so as to approach a central axis (L) of the through hole (26) in a direction from the front surface (21a) toward the collar placement region (41).

Appendix 2

In an aspect of the present disclosure, a radially outermost edge of an upper end of the collar (16) may coincide with a radially innermost edge (42a) of the inclined region (42).

Appendix 3

In an aspect of the present disclosure, an end face of the collar (16) that faces the inside of the inclined region (42) of the through hole (26) may define a plane orthogonal to the central axis (L) of the through hole (26).

Appendix 4

In an aspect of the present disclosure, the holding part (22) may include a tube defining portion (23) that is molded in a single piece with the fixed portion (21), and a cover portion (24),

the tube defining portion (23) may have a lateral opening on a side that is continuous with the front surface (21a), and the cover portion (24) may close the lateral opening, and

an outer surface of the cover portion (24) may be flush with the front surface (21a).

Appendix 5

In an aspect of the present disclosure, an inner surface of the cover portion (24) may include an arc surface.

Appendix 6

In an aspect of the present disclosure, the collar (16) may include a flange portion (32) extending radially outward from an end portion of the collar (16) on the front surface (21a) side, and

the through hole (26) may include, at an end portion of the collar placement region (41) on the inclined region (42) side, a step portion (43) that abuts against the flange portion (51) in the axial direction of the collar (16) from the back surface (21b) side.

Appendix 7

In an aspect of the present disclosure, the collar (16) may include a flange portion (51) extending radially outward from an end portion of the collar (16) on the back surface (21b) side, and

the through hole (26) may include, at an end portion of the collar placement region (41) on a side opposite to the inclined region (42), a step portion that abuts against the flange portion (51) in the axial direction of the collar (16) from the front surface (21a) side.

Appendix 8

In an aspect of the present disclosure, the through hole (26) may include, at an end portion of the collar placement region (41) on the inclined region (42) side, an abutment portion (61) that abuts against an end portion of the collar (16) on the front surface (21a) side in the axial direction of the collar (16) from the front surface (21a) side.

### LIST OF REFERENCE NUMERALS

10 Wire harness

11 Wire harness body

12 Fixing member (wire harness fixing member)

13 Wire

14 Exterior member

15 Fixing member body

16 Collar

16a Inner circumferential surface

21 Fixed portion

21a Front surface

21b Back surface

22 Holding part

23 Body-side portion

24 Cover portion

25 Recess

26 Through hole

31 Collar body portion

31a End portion

32 Flange portion

41 Collar placement portion

42 Inclined portion

42a End portion

42b End portion

43 Step portion

51 Flange portion

61 Abutment portion

L Central axis

P Vehicle body panel (mounting target)

Pa Attachment surface

Pb Bolt

Pc Nut

1. A wire harness fixing member for fixing a wire harness body to a mounting target, comprising:
a fixing member body; and
a tubular collar that is separate from the fixing member body,
wherein the fixing member body includes a fixed portion configured to be fixed to a bolt extending from an attachment surface of the mounting target, and a holding part that holds the wire harness body,
the fixed portion includes a front surface that opposes the attachment surface, and a through hole that extends therethrough from the front surface to a back surface side and in which the collar is provided,
the bolt is passed through the collar,
an inner circumferential surface of the through hole includes a collar placement portion in which the collar is disposed, and an inclined portion located between the collar placement portion and the front surface, and
the inclined portion is inclined from the front surface to a central axis side of the through hole toward the collar placement portion side.

2. The wire harness fixing member according to claim 1,
wherein the collar has an inner diameter that is uniform in an axial direction thereof.

3. The wire harness fixing member according to claim 1,
wherein the collar includes a flange portion extending radially outward from one end portion of the collar in the axial direction, and
the through hole includes, at an end portion of the collar placement portion on the inclined portion side, a step portion that abuts against the flange portion in the axial direction of the collar.

4. The wire harness fixing member according to claim 1,
wherein a radial position of an end portion of the inclined portion on the collar placement portion side coincides with a position of an inner circumferential surface of the collar, as viewed in the axial direction of the collar.

5. A wire harness comprising:
a wire harness body; and
the wire harness fixing member according to claim 1.
